(19) United States
(12) Patent Application Publication
(10) Pub. No.: US 2004/0179007 A1
(43) Pub. Date: Sep. 16, 2004

(54) Method, node, and network for transmitting viewable and non-viewable data in a compositing system

(76) Inventors: K. Scott Bower, Fort Collins, CO (US); Byron A. Alcorn, Fort Collins, CO (US); Courtney D. Goeltzenleuchter, Fort Collins, CO (US); Kevin T. Lefebvre, Fort Collins, CO (US); James A. Schinnerer, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/388,874

(22) Filed: Mar. 14, 2003

(51) Int. Cl. G06T 15/00

(52) U.S. Cl. 345/419

(57) ABSTRACT

A node of a network for generating image frames comprising a graphics device operable to generate a viewable data set and a non-viewable data set representative of a three-dimensional image frame, and a first output interface operable to transmit the non-viewable data set is provided. A network for generating image frames comprising a plurality of rendering nodes operable to respectively generate a viewable data set and a non-viewable data set, and further operable to transmit the viewable and non-viewable data sets, and a compositor interconnected with the plurality of rendering nodes and operable to respectively receive the viewable and non-viewable data sets from the plurality of rendering nodes and operable to assemble a composite image from the viewable and non-viewable data sets is provided.

### TECHNICAL FIELD OF THE INVENTION

This invention relates to a computer graphical display system and, more particularly, to a method, node, and network for generating an image frame for a compositing system.

### BACKGROUND OF THE INVENTION

Designers and engineers in manufacturing and industrial research and design organizations are today driven to keep pace with ever-increasing design complexities, shortened product development cycles and demands for higher quality products. To respond to this design environment, companies are aggressively driving front-end loaded design processes where a virtual prototype becomes the medium for communicating design information, decisions and progress throughout their entire research and design entities. What was once component-level designs that were integrated at manufacturing have now become complete digital prototypes—the virtual development of the Boeing 777 airliner is one of the more sophisticated and well-known virtual designs to date.

With the success of an entire product design in the balance, accurate, real-time visualization of these models is paramount to the success of the program. Designers and engineers require availability of visual designs in up-to-date form with photo-realistic image quality. The ability to work concurrently and collaboratively across an extended enterprise often having distributed locales is critical to a program's operability and success. Furthermore, virtual design enterprises require scalability so that the virtual design environment can grow and accommodate programs that become increasingly complex.

Compositing solutions are often implemented in a rendering system to improve the performance of a graphical display system. An image may be geometrically defined by a plurality of geometric data sets that respectively define portions of the image. Multiple rendering nodes are deployed in the graphical display system and each rendering node is responsible for processing an image portion. In a three-dimensional (3-D) graphic display system, each rendering node is responsible for generating viewable data and non-viewable data from a geometric data set that are processed for the production of an image frame. Image frames comprising viewable data processed in accordance with non-viewable data are transmitted to a compositor where individual frames are assembled into a contiguous image and provided to one or more display devices for viewing. Thus, the compositor is limited to performing compositing functions only on the processed viewable data.

### SUMMARY OF THE INVENTION

Heretofore, only viewable data of a generated image frame has been transmitted from a rendering node to a compositor.

In accordance with an embodiment of the present invention, a node of a network for generating image frames comprising a graphics device operable to generate a viewable data set and a non-viewable data set representative of a three-dimensional image frame, and a first output interface operable to transmit the non-viewable data set is provided.

In accordance with another embodiment of the present invention, a method of generating an image frame for assembly by a compositing system comprising generating a viewable data set and a non-viewable data set from a geometric data set, and transmitting, by a rendering node, the viewable and non-viewable data sets to a compositor is provided.

In accordance with another embodiment of the present invention, a network for generating image frames comprising a plurality of rendering nodes operable to respectively generate a viewable data set and a non-viewable data set, and further operable to transmit the viewable and non-viewable data sets, and a compositor interconnected with the plurality of rendering nodes and operable to respectively receive the viewable and non-viewable data sets from the plurality of rendering nodes and operable to assemble a composite image from the viewable and non-viewable data sets is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of a conventional computer graphical display system;

FIG. 2 is a block diagram of an exemplary scaleable visualization system in which an embodiment of the present invention may be implemented for advantage;

FIGS. 3A and 3B are image schematics comprising image objects that may be defined by respective geometric data sets according to an embodiment of the present invention;

FIG. 4 is a simplified block diagram of a compositing system in which rendering nodes generate and transmit respective viewable and non-viewable data sets to a compositing node according to an embodiment of the present invention;

FIG. 5 is simplified schematic of an alternative graphics device comprising a plurality of display units conventionally configured and in which embodiments of the present invention may be implemented to advantage;

FIG. 6 is a block diagram of a compositing system comprising rendering nodes having graphics devices similar to that described with reference to FIG. 5 and configured according to another embodiment of the present invention;

FIG. 7 is a block diagram of a master system that may be implemented in a compositing system according to an embodiment of the present invention;

FIG. 8 is a block diagram of a rendering node configured as a master rendering node according to an embodiment of the present invention; and

FIG. 9 is a block diagram of a configuration of rendering nodes according to a preferred embodiment of the present invention.

### DETAILED DESCRIPTION OF THE DRAWINGS

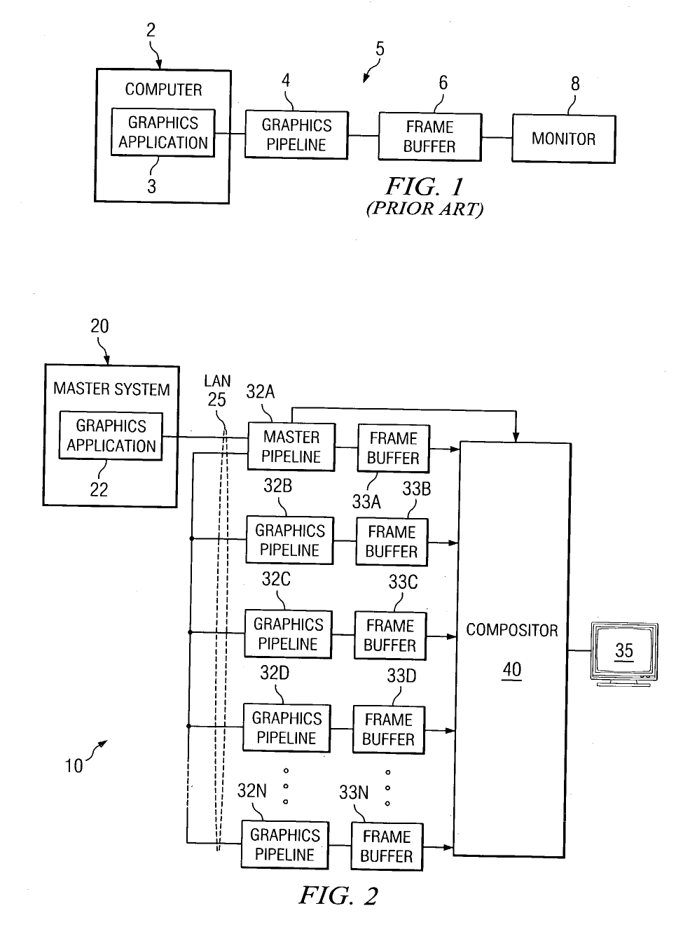

The preferred embodiment of the present invention and its advantages are best understood by referring to FIGS. 1 through 9 of the drawings, like numerals being used for like and corresponding parts of the various drawings.

FIG. 1 is a block diagram of an exemplary conventional computer graphical display system 5. A graphics application 3 stored on a computer 2 provides data necessary for system 5 to generate a three-dimensional (3-D) rendering of an image. To render the image, application 3 transmits geometric data geometrically defining the image and attributes thereof to graphics pipeline 4, which may be implemented in hardware, software, or a combination thereof. Graphics pipeline 4, through well-known techniques, processes the geometric data received from application 3 and may update an image frame maintained in a frame buffer 6. Frame buffer 6 stores an image frame comprising graphical data necessary to define the image to be displayed by a monitor 8. In this regard, frame buffer 6 includes a viewable set of data for each pixel displayed by monitor 8. Each pixel value of the image frame is correlated with the coordinate values that identify one of the pixels displayed by monitor 8, and each set of data includes the color value of the identified pixel as well as any additional information needed to appropriately color or shade the identified pixel. Normally, frame buffer 6 transmits the viewable graphical data stored therein to monitor 8 via a scanning process such that each line of pixels defining the image displayed by monitor 8 is sequentially updated.

FIG. 2 is a block diagram of an exemplary scaleable visualization system 10 including graphics pipelines 32A-32N in which an embodiment of the present invention may be implemented for advantage. Visualization system 10 includes master system 20 interconnected, for example via a network 25 such as a gigabit local area network, with master pipeline 32A that is connected with one or more slave pipelines 32B-32N that may be implemented as graphics-enabled workstations. Master system 20 may be implemented as an X server and may maintain and execute a high performance three-dimensional rendering application, such as OPENGL. Renderings may be distributed from one or more pipelines 32A-32N across visualization system 10, assembled by a compositor 40, and displayed on a display device 35 as a single, contiguous image.

Master system 20 runs a graphics application 22, such as a computer-aided design/computer-aided manufacturing (CAD/CAM) application, a graphics multimedia application, or another graphics application implemented on a computer-readable medium comprising a computer-readable instruction set(s) executable by a conventional processing element, and may control and/or run a process, such as X server, that controls a bitmap display device and distributes 3-D data to multiple 3-D rendering nodes 32A-32N.

Graphics pipelines 32A-32N may be responsible for rendering to a portion, or sub-screen, of a full application visible frame buffer. In such a scenario, each graphics pipeline 32A-32N defines a screen space division that may be distributed for application rendering requests. For example, graphics pipeline 32B-32N may each respectively generate a data set representative of a unique quadrant of a 3-D image; compositor 40 may assemble the image quadrants into a complete composite image—a compositing technique referred to herein as screen space compositing. A digital video connector, such as a digital video interface (DVI), may provide connections between rendering nodes 32A-32N and compositor 40.

Image compositor 40 is responsible for assembling sub-screen image frames, or image portions, from respective frame buffers and combining the multiple sub-screen image frames into a single screen image for presentation on display device(s) 35 in one conventional configuration. For example, compositor 40 may assemble sub-screen image frames provided by frame buffers 33A-33N where each sub-screen image frame is a rendering of a distinct, non-overlapping portion of a composite image when system 10 is configured in a screen space compositing mode. In this manner, compositor 40 merges a plurality of sub-screen image frames each representative of a respective image portion provided by pipeline 32A-32N into a single, composite image prior to display of the final image. Compositor 40 may also operate in an accumulate mode in which all pipelines 32A-32N provide image frames representative of a complete image. In the accumulate mode, compositor 40 sums the pixel output from each graphics pipeline 32A-32N and averages the result prior to display. Other modes of operation are possible. For example, a screen may be partitioned and have multiple pipelines assigned to a particular partition while other pipelines are assigned to one or more remaining partitions in a mixed-mode (that is, a combination of screen space and accumulate mode compositing) of operation. Thereafter, sub-screens provided by graphics pipelines assigned to a common screen space partition are averaged, as in the accumulate mode, and the screen space partitions are then assembled into a contiguous image in accordance with screen space compositing techniques. Thus, visualization system 10 provides for improved performance, such as an enhanced frame rate, over the graphical display system 5 described in FIG. 1, by distributing the graphical processing requirements over a plurality of pipelines 32A-32N.

It should be understood that the compositing techniques described are exemplary only and are chosen to facilitate an understanding of the invention. A characteristic of all above-described compositing techniques is that graphics pipelines 32A-32N generate a viewable and a non-viewable data set, such as a data set comprising transparency (α) and depth (z) data, that are conjunctively processed for production of an image frame that is conveyed to respective frame buffer 33A-33N. As used hereinbelow, “image frame” may refer to a complete screen image frame of a sub-screen image frame unless explicitly stated otherwise. Accordingly, only viewable data, e.g., red, green, blue (RGB) pixel data (that is, data comprising the image frame), is transmitted to compositor 40 according to conventional compositing techniques.

Master system 20 may provide geometric data that geometrically defines an image to a respective graphics pipeline 32A-32N. The geometric data may define the image perspective by specifying a 3-D image viewpoint in accordance with a 3-D coordinate system, e.g., a Cartesian coordinate system, a polar coordinate system, etc. Other data may be included with the geometric data set, such as a simulated lighting specification (e.g., a lighting intensity and/or location), an image surface attribute (such as a surface gradient), and/or another attribute used for rendering an image. In the illustrative example, master system 20 is communicatively coupled with a master graphics pipeline 32A that produces two-dimensional (2-D) image frame data and conveys the 2-D image frame data to frame buffer 33A. Additionally, master graphics pipeline 32A routes geometric data required for generating 3-D image frames to graphics pipelines 32B-32N which generate and convey the 3-D image frame data to frame buffers 33B-33N. Such a configuration is exemplary only and enables at least one or more nodes to be dedicated to processing and rendering 2-D data while other nodes are dedicated to processing and rendering 3-D data. Regardless of the particular configuration, graphics pipelines 32A-32N are supplied with geometric data sets and produce respective image frames by processing viewable data and associated non-viewable data generated from the geometric data. The viewable data may comprise red-, green-, and blue-formatted data, such as a pixel map. Preferably, each pixel value of the viewable data set has at least one corresponding data value in the non-viewable data set, e.g., an a and/or z value, assigned thereto. Conventionally, frame buffers 33A-33N transmit the image frame data (i.e., the viewable data set processed in accordance with the non-viewable data set) stored therein to compositor 40 via a scanning process such that each line of pixels defining the image displayed by display device 35 is sequentially updated. Thus, each of pipelines 32A-32N receive a respective geometric data set and generate viewable and non-viewable data sets therefrom. The viewable and non-viewable data sets are conjunctively processed by graphics pipelines 32A-32N and produce respective image frames that are conveyed to frame buffer 33A-33N and transferred therefrom to compositor 40 where a contiguous image is assembled for display. Production of image frames by pipeline 32A-32N is generally performed by processing of the viewable data set with the non-viewable data set, such as performing alpha blending and depth testing as is understood in the art. Other graphics processing procedures necessary for appropriate pixel shading and spatial resolution may be substituted for, or in combination, with alpha blending and/or depth sorting procedures. Only image frames comprising viewable data (processed in accordance with the non-viewable data) are transmitted to the compositor for assembly thereby according to conventional compositing techniques.

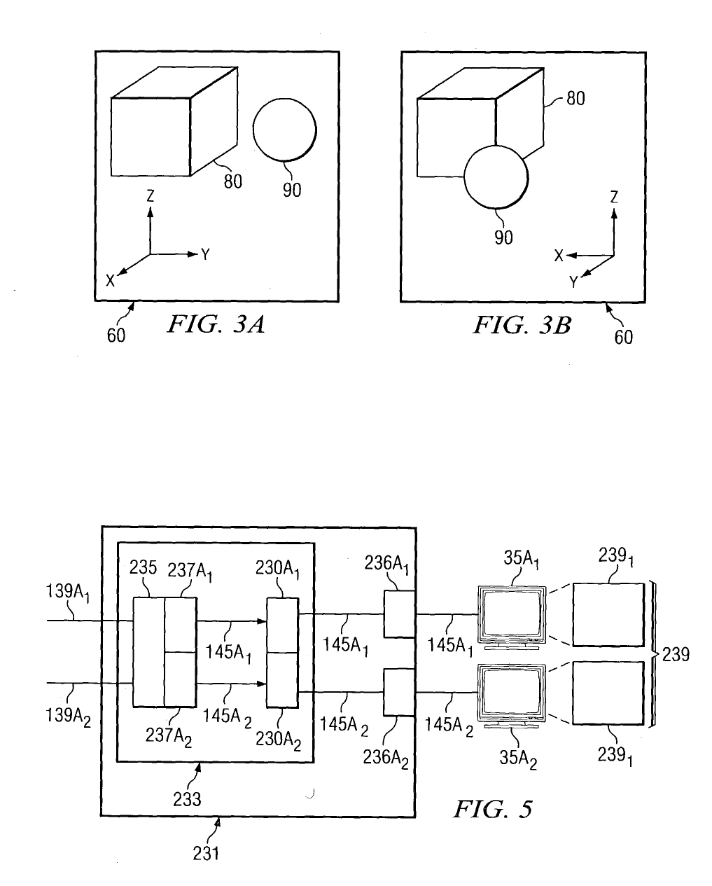

In contrast to existing systems, however, embodiments of the present invention facilitate an enhanced compositing solution by transmitting both the generated viewable data sets and the associated non-viewable data sets to a compositor node. A particular advantage of the present invention is that an image may be partitioned into constituent image components, or image objects, as opposed to screen space partitions (as is the case in screen space compositing) and the compositor node (rather than the rendering nodes) may perform depth sorting and alpha blending regardless of the spatial relation among the constituent image objects at a particular image orientation. For example, a 3-D image of a cube and a sphere may be partitioned into a respective cube object 80 and sphere object 90 according to an embodiment of the invention and as illustrated by the image schematic 60 of FIG. 3A. One rendering node may be responsible for generating viewable and non-viewable data sets that define cube object 80 at a particular image perspective defined by a geometric data set. Another rendering node may be responsible for generating viewable and non-viewable data sets that define sphere object 90 at a perspective defined by another geometric data set. In such an implementation, each rendering node requires a and z data associated with the partitioned image object to generate respective image frames of the cube and sphere object. However, processing of an image object by one rendering node is performed mutually independent of processing of any other image objects by another rendering node(s). For example, a rendering node provided with geometric data defining only sphere object 90 and its associated attributes is not capable of resolving any spatial relations between cube object 80 and sphere object 90. At the image perspective shown in FIG. 3A, for example, both cube object 80 and sphere object 90 are fully non-occluded and within the field of view. However, at another perspective, one image object may occlude another image object (or a portion thereof), as shown by the image schematic 60 of FIG. 3B in which the image perspective has been rotated by 90 degrees. Accordingly, generation of an image frame comprising the partitioned image objects is not facilitated by image frames generated by individual rendering nodes. Embodiments of the present invention enhance the performance of a graphics compositing system by enabling an image to be partitioned into constituent image objects by transmitting a viewable and non-viewable data set to a compositor node such that the compositor node may perform depth testing and alpha blending of the received viewable data sets prior to assembling a composite image. Accordingly, the compositor is able to resolve spatial relations among respective image frames produced from viewable and non-viewable data sets. It should be understood that the illustrative compositing technique described with reference to FIGS. 3A and 3B is only an exemplary utilization of the present invention. The embodiments of the present invention for delivering both viewable and non-viewable data to a compositing node may find advantageous application in other compositing solutions, including screen-space, accumulate, and mixed mode compositing systems, as well.

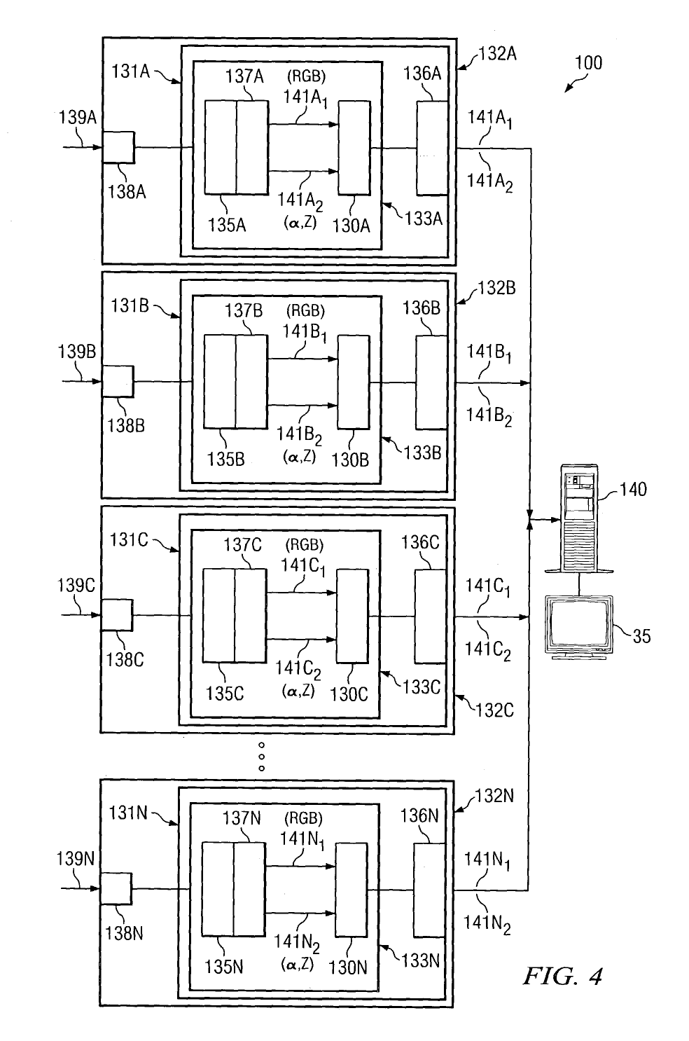

FIG. 4 is a simplified block diagram of a compositing system 100 in which rendering nodes 132A-132N generate a viewable data set 141A₁-141N₁ and a non-viewable data set 141A₂-141N₂ from a respective geometric data set 139A-139N, and that transmits the viewable and non-viewable data sets 141A₁-141N₁ and 141A₂-141N₂, respectively, to a compositor 140 for processing and assembly thereof according to an embodiment of the present invention. Compositing system 100 may have a master system implemented similar to master system 20 described hereinabove with reference to FIGS. 1 and 2. Master system 20 provides one or more rendering nodes 132A-132N with respective geometric data sets 139A-139N, each data set comprising data that geometrically defines an image at a particular perspective, or orientation, and various other image attributes as discussed above. The images respectively defined by geometric data sets 139A-139N may comprise an image portion, a full screen image, or an image object depending on the particular compositing solution employed. Preferably, master system 20 and each of rendering nodes 132A-132N are respectively implemented via stand-alone computer systems, or workstations. However, it is possible to implement master system 20 and rendering nodes 132A-132N in other configurations. Master system 20 and rendering nodes 132A-132N may be interconnected via a local area network and, accordingly, geometric data sets 139A-139N may be conveyed to rendering nodes 132A-132N via a standard network interface and rendering nodes 132A-132N may be equipped with a respective network interface card 138A-138N such as an Ethernet card.

Each rendering node 132A-132N is equipped with a respective graphics device 131A-131N, such as a graphics processing board, capable of driving a display device. Graphics devices 131A-131N may respectively comprise a functional element referred to as a display unit 130A-130N. Display units 130A-130N may be implemented as a chipset 133A-133N disposed on respective graphics devices 131A-131N and are operable to dump information stored in frame buffer 137A-137N to a display device. Frame buffer 137A-137N, as well as a graphics pipeline 135A-135N, may be disposed in respective chipsets 133A-133N. In the configuration shown, rendering nodes 132A-132N (and thus graphics devices 131A-131N) are communicatively coupled with a compositor 140. Accordingly, graphics devices 131A-131N are preferably configured to process geometric data sets 139A-139N, and generate and convey viewable data sets 141A₁-141N₁ and associated non-viewable data set 141A₂-141N₂ to respective frame buffers 137A-137N. The viewable and non-viewable data sets 141A₁-141N₁ and 141A₂-141N₂ are subsequently dumped to an output interface 136A-136N via display units 130A-130N according to an embodiment of the present invention. Preferably, output interfaces 136A-136N are implemented as digital video interface (DVI) outputs although other output interfaces may be substituted therefor. By providing compositor 140 with viewable and non-viewable data sets 141A₁-141N₁ and 141A₂-141N₂, depth sorting and alpha blending may be performed by compositor 140 and spatial relationships among various image frames produced from respective viewable and non-viewable data sets 141A₁-141N₁ and 141A₂-141N₂ may be advantageously resolved by compositor 140. Individual image frames produced by processing of viewable and non-viewable data sets 141A₁-141N₁ and 141A₂-141N₂ are then assembled into a contiguous image frame and conveyed to a display device(s) 35.

In the illustrative example, both viewable and non-viewable data sets 141A₁-141N₁ and 141A₂-141N₂ are conveyed to frame buffer 137A-137N prior to transmission thereof to compositor 140. In such a configuration, data sets 141A₁-141N₁ and 141A₂-141N₂ are respectively output via output interfaces 136A-136N. Viewable and non-viewable data sets 141A₁-141N₁ and 141A₂-141N₂ may be multiplexed over a common output interface 136A-136N. However, other configurations of compositing system 100 may be implemented to further enhance system performance. For example, non-viewable data sets 141A₂-141N₂ may be transferred from rendering nodes 132A-132N over a different output interface than viewable data sets 141A₁-141N₁ thereby improving the achievable frame rate.

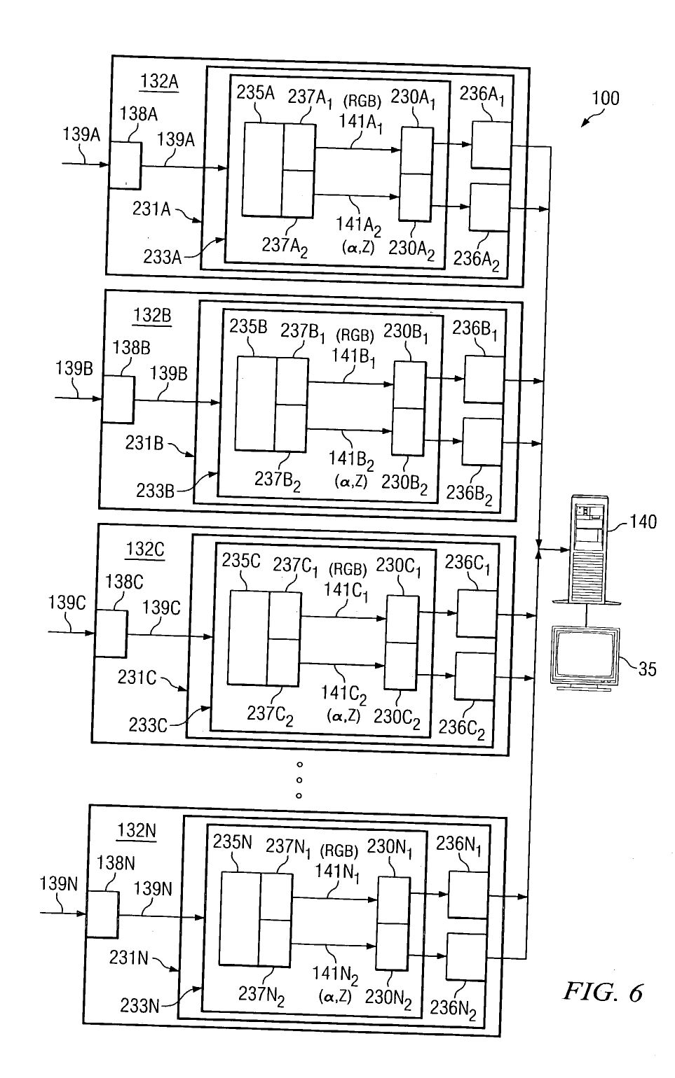

FIG. 5 is simplified schematic of an alternative graphics device 231 conventionally configured and in which embodiments of the present invention may be implemented to advantage. Graphics device 231 may be configured in accordance with an embodiment of the invention and substituted for the graphics devices described hereinabove with reference to FIG. 4 for implementation of an improved compositing solution according to another embodiment of the present invention as described more fully hereinbelow with reference to FIG. 6. Graphics device 231 comprises a plurality of display units 230A₁ and 230A₂ each operable to drive a respective display device 35A₁ and 35A₂. Graphics pipeline 235 may receive a plurality of geometric data sets 139A₁ and 139A₂ and produce respective image frames 145A₁ and 145A₂ therefrom by generating a viewable data set and an associated non-viewable data set in accordance with the geometric data. In the illustrative example, two image frames 145A₁-145A₂ comprising viewable data, such as red-, green-, and blue-formatted data, may be concurrently generated and provided to frame buffers 237A₁ and 237A₂. Image frame 145A₁ generated by graphics pipeline 235 and provided to frame buffer 237A₁ is representative of an upper image half 2391 and image frame 145A₂ provided to frame buffer 237A₂ is representative of a bottom image half 2392. In the illustrative example, geometric data sets 139A₁ and 139A₂ geometrically define image attributes necessary to render upper image half 239, and lower image half 2392, although a single geometric data set may be used for generating image frames 145A₁ and 145A₂. Display units 230A₁ and 230A₂ are operable to dump image frames 145A₁ and 145A₂ maintained in associated frame buffers 237A₁ and 237A₂ to respective output interfaces 236A₁ and 236A₂ such that display devices 35A₁ and 35A₂ are refreshed according to the most recent geometric data. It should be noted that display units 230A₁ and 230A₂ are logical entities and may be deployed on a common circuit of graphics device 231. For example, graphics device 231 may comprise a single chipset 233 comprising multiple display units 230A₁ and 230A₂ disposed thereon. Likewise, frame buffers 237A₁ and 237A₂ may be disposed on chipset 233 as well. Additionally, graphics pipeline 235 may be located on chipset 233 and is preferably operable to receive a plurality of geometric data sets 139A₁ and 139A₂ and concurrently generate a corresponding plurality of data sets of viewable and non-viewable data from which image frames 145A₁ and 145A₂ are produced. While graphics pipeline 235 is illustratively shown as located on chipset 233, functionality of graphics pipeline 235 (or a portion thereof) may be implemented in software as well. Preferably, graphics device 231 comprises output interfaces 236A₁ and 236A₂, such as dual DVIs, for outputting buffered image frames via respective display units 230A₁ and 230A₂.

FIG. 6 is a block diagram of compositing system 100 comprising rendering nodes 132A-132N having respective graphics devices 231A-231N similar to graphics device 231 described with reference to FIG. 5 but configured according to an embodiment of the present invention. Compositing system 100 may have a master system implemented similar to master system 20 described hereinabove with reference to FIGS. 1 and 2. The master system provides rendering nodes 132A-132N with respective geometric data set 139A-139N. Each rendering node 132A-132N is equipped with respective graphics device 231A-231N comprising pairs of display units 230A₁ and 230A₂-230N₁ and 230N₂ each operable to drive a display device. However, in the illustrative embodiment, graphics devices 231A-231N are configured to output viewable and non-viewable data sets rather than image frames. Pairs of display units 230A₁ and 230A₂-230N₁ and 230N₂ are preferably implemented on a respective chipset 233A-233N disposed on graphics device 231A-231N. Additionally, chipset 233A-233N may comprise respective frame buffers 237A₁ and 237A₂-237N₁ and 237N₂ and a graphics pipeline 235A-235N operable to generate respective viewable data set 141A₁-141N₁ and non-viewable data set 141A₂-141N₂ from geometric data set 139A-139N. Graphics pipeline 235A-235N conveys the generated viewable data set 141A₁-141N₁ to a respective frame buffer 237A₁-237N₁ and the associated non-viewable data set 141A₂-141N₂ to another frame buffer 237A₂-237N₂. Accordingly, one display unit 230A₁-230N₁ conveys viewable data set 141A₁-141N₁ maintained in frame buffer 237A₁-237N₁ to compositor 140 via a first output interface 236A₁-236N₁ and another display unit 230A₂-230N₂ conveys non-viewable data set 141A₂-141N₂ maintained in frame buffer 237A₂-237N₂ to compositor 140 via a second output interface 236A₂-236N₂. Compositor 140 may then resynchronize the viewable data and the non-viewable data and depth testing and alpha blending may then be performed for production of respective image frames. Image frames produced by the compositor from respective viewable and non-viewable data sets are then assembled into a format suitable for display by display device(s) 35.

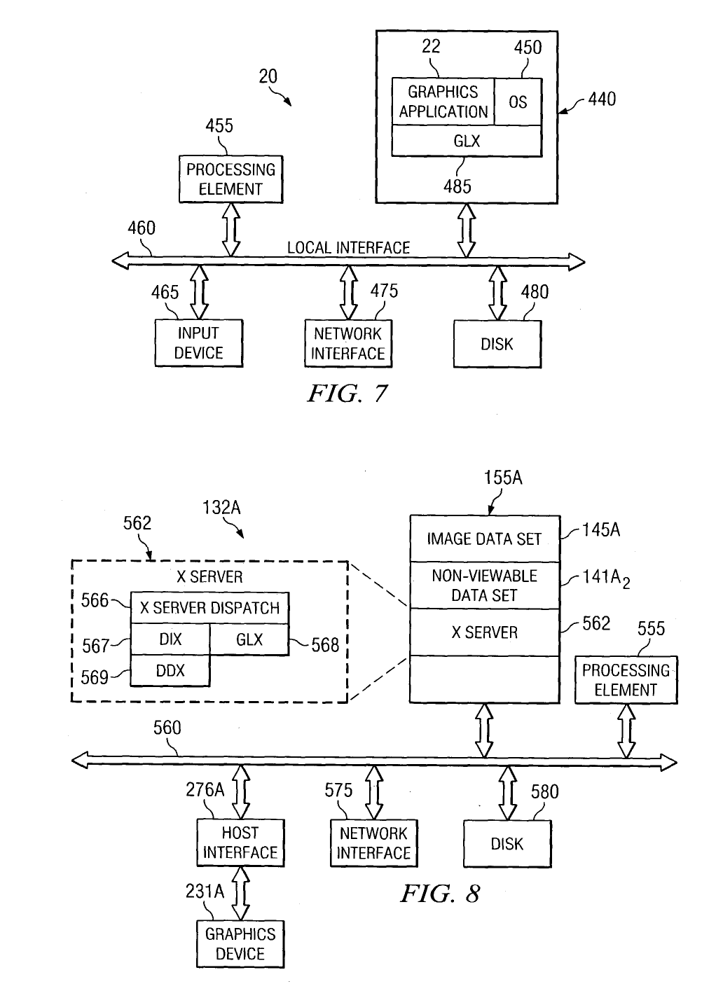

FIG. 7 is a block diagram of master system 20 that may be implemented in compositing system 100 according to an embodiment of the present invention. Master system 20 stores graphics application 22 in a memory unit 440. Through conventional techniques, application 22 is executed by an operating system 450 and at least one processing element 455 such as a central processing unit. Operating system 450 performs functionality similar to conventional operating systems, controls the resources of master system 20, and interfaces the instructions of application 22 with processing element 455 to enable application 22 to properly run.

Processing element 455 communicates with and drives the other elements within master system 20 via a local interface 460, which may comprise one or more buses. Furthermore, an input device 465, for example a keyboard or a mouse, can be used to input data from a user of master system 20. A disk storage device 480 can be connected to local interface 460 to transfer data to and from a nonvolatile disk, for example a magnetic disk, optical disk, or another device. Master system 20 preferably comprises a network interface 475 such as an Ethernet card that facilitates exchanges of data with rendering nodes 132A-132N.

In an embodiment of the invention, X protocol is utilized to render 2-D graphical data, and the OPENGL protocol (OGL) is utilized to render 3-D graphical data, although other types of protocols may be utilized in other embodiments. By way of background, the OPENGL protocol is a standard application programmer's interface to hardware that accelerates 3-D graphics operations. Although the OPENGL protocol is designed to be window system-independent, it is often used with window systems such as the X Windows system. In order that the OPENGL protocol may be used in an X. Windows environment, an extension of X Windows is used and is referred to herein as GLX. When application 22 issues a graphical command, a client-side GLX layer 485 of master system 20 transmits the command to a rendering node designated as the master rendering node, for example rendering node 132A. In the illustrative embodiment, a graphical command comprises geometric data that defines an image and attributes thereof, e.g., location of simulated lighting, surface gradients, etc., although other image attributes may be included with, or substituted for, the geometric data.

With reference now to FIG. 8, there is illustrated a block diagram of rendering node 132A configured as a master rendering node that may be implemented in compositing system 100 according to an embodiment of the present invention. Rendering node 132A comprises one or more processing elements 555 that communicate with and drive other elements of rendering node 132A via a local interface 560. A disk storage device 580 can be connected to local interface 560 to transfer data therebetween. Rendering node 132A preferably comprises a network interface 575 that enables an exchange of data with a LAN or another network device interfacing rendering nodes 132B-132N.

Rendering node 132A may include an X server 562 implemented in software and stored in a memory device 155A. Preferably, X server 562 renders 2-D X window commands, such as commands to create or move an X window. In this regard, an X server dispatch layer 566 is designed to route received commands to a device independent layer (DIX) 567 or to a GLX layer 568. An X window command that does not include 3-D data is interfaced with DIX 567. An X window command that does include 3-D data is routed to GLX layer 568 (e.g., an X command having an embedded OGL command, such as a command to create or change the state, such as an orientation, of a 3-D image within an X window). A command interfaced with DIX 567 is executed thereby and potentially by a device dependent layer (DDX) 569, which conveys graphical data (e.g., viewable and non-viewable data) generated from execution of the command to frame buffer 137A (FIG. 4) or one or more of frame buffers 237A₁ and 237A₂ (FIG. 6).

Rendering node 132A may comprise graphics device 131A (FIG. 4) for processing data sets representative of images as aforedescribed. Graphics device 131A may be implemented as an expansion card interconnected with a host interface 276A disposed on a backplane, e.g. a motherboard, of rendering node 132A. Host interface 276A may comprise a peripheral computer interconnect, a universal serial bus, a parallel port, a serial port, or another suitable interface. Rendering node 132A implemented with graphics device 131A may be configured to output both viewable and non-viewable data sets 141A₁ and 141A₂ over output interface 136A (FIG. 4). Output of viewable data set 141A₁ and non-viewable data set 141A₂ over output interface 136A may be facilitated by multiplexing of the data sets. Alternatively, viewable and non-viewable data sets 141A₁ and 141A₂ may be sequentially transmitted over output interface 136A. Output of both viewable and non-viewable data sets 141A₁ and 141A₂ over output interface 136A requires a single interface, such as a digital video interface, to be deployed on compositor 140 for receiving both data sets 141A₁ and 141A₂.

Preferably, however, rendering node 132A comprises graphics device 231A having multiple display units 230A₁ and 230A₂ and frame buffers 237A₁ and 237A₂ configured as described hereinabove with reference to FIG. 6. Viewable and non-viewable data sets 141A₁ and 141A₂ are output to compositor 140 via respective output interfaces 236A₁ and 236A₂, such as dual DVIs, of graphics device 231A. In such a configuration, compositor 140 is implemented with dual DVIs for respectively receiving data sets 141A₁ and 141A₂.

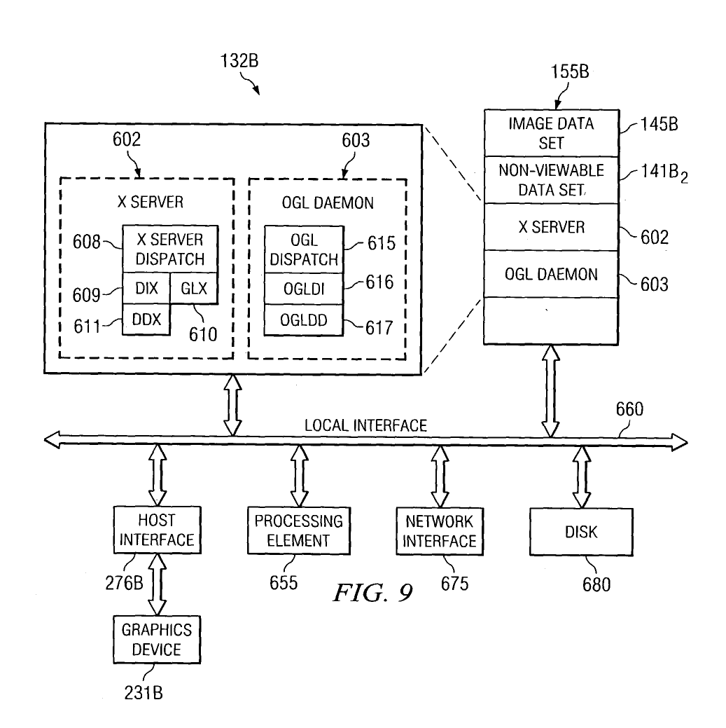

FIG. 9 is a block diagram of a preferred configuration of rendering node 132B according to an embodiment of the present invention although other configurations are possible. Each of rendering nodes 132C-132N is preferably configured in a similar manner as rendering node 132B. Rendering node 132B includes an X server 602, similar to X server 562 discussed hereinabove, and an OGL daemon 603. X server 602 and OGL daemon 603 are implemented in software and stored in a memory device 155B. Rendering node 132B preferably includes one or more processing elements 655 that communicates with and drives other elements of rendering node 132B via a local interface 660. A disk storage device 680 can be connected to local interface 660 to transfer data to and from a nonvolatile disk. Rendering node 132B preferably comprises a network interface 675 for enabling exchange of data with a LAN or another network device interconnecting rendering nodes 132A-132N.

X server 602 comprises an X server dispatch layer 608, a DIX layer 609, a GLX layer 610, and a DDX layer 611. X server dispatch layer 608 interfaces the 2-D data of any received commands with DIX layer 609 and interfaces the 3-D data of any received commands with GLX layer 610. DIX layer 609 and DDX layer 611 are configured to process or accelerate the 2-D data and to drive the 2-D data to frame buffer 137B (FIG. 4) or one or more frame buffers 237B₁ and 237B₂ (FIG. 6).

GLX layer 610 interfaces the 3-D data with OGL dispatch layer 615 of OGL daemon 603. OGL dispatch layer 615 interfaces this data with an OGL DI layer 616. OGL DI layer 616 and OGL DD layer 617 are configured to process the 3-D data and to accelerate or drive the 3-D data to frame buffer 137B or 237B₁ and 237B₂. Thus, the 2-D-graphical data of a received command is processed or accelerated by X server 602, and the 3-D-graphical data of the received command is processed or accelerated by OGL daemon 603.

Similar to the various configurations of rendering node 132A, rendering node 132B may be implemented with respective graphics device 131B comprising a single display unit 130B, frame buffer 137B, and output interface 136B and may be configured to output both viewable and non-viewable data sets 141B₁ and 141B₂ over output interface 136B. Output of viewable data set 141B₁ and non-viewable data set 141B₂ over output interface 136B may be facilitated by multiplexing data sets 141B₁ and 141B₂. In yet another configuration, viewable and non-viewable data sets 141B₁ and 141B₂ may be sequentially transmitted over output interface 136B and compositor 140 is equipped with a input interface, such as a DVI, for receipt thereof.

In a preferred embodiment illustrated in FIGS. 6 and 9, rendering node 132B comprises graphics device 231B having multiple display units 230B₁ and 230B₂, frame buffers 237B₁ and 237B₂, and output interfaces 236B₁ and 236B₂ implemented as an expansion card interconnected with a host interface 276B disposed on a backplane of rendering node 132B. Viewable data set 141B₁ and non-viewable data set 141B₂ are output to compositor 140 via respective output interfaces 236B₁ and 236B₂, such as dual DVIs. In such a configuration, compositor 140 is implemented with a dual DVI pair for receiving each of data sets 252B₁ and 141B₂. Compositor 140 may then resynchronize the viewable and non-viewable data and depth testing and alpha bending may then be performed for production of respective images frames.

Preferably, viewable and non-viewable data sets are processed by compositor 140 for production of constituent image object(s) of an image. Accordingly, viewable and non-viewable data sets 141A₁-141N₁ and 141A₂-141N₂ may be generated in mutual independence by rendering nodes 132A-132N and compositor 140 may produce image frames and assemble a composite image therefrom regardless of whether the respective image objects are occluded, in whole or in part, by other image objects.

What is claimed:

1. A node of a network for generating image frames, comprising:
a graphics device operable to generate a viewable data set and a non-viewable data set representative of a three-dimensional image frame; and
a first output interface operable to transmit the non-viewable data set.

2. The node according to claim 1, wherein the first output interface is disposed on the graphics device.

3. The node according to claim 1, wherein the graphics device further comprises a second output interface, the node operable to transmit the viewable data set through the second output interface.

4. The node according to claim 3, wherein the first and second output interfaces respectively comprise first and second digital video interfaces.

5. The node according to claim 3, wherein the graphics device further comprises a first and second display unit communicatively coupled with a first and second frame buffer, the non-viewable and viewable data sets conveyed to the first and second output interfaces by the first and second display units.

6. The node according to claim 1, further comprising a graphics pipeline operable to receive a geometric data set, the viewable and the non-viewable data sets generated from the geometric data set.

7. The node according to claim 1, wherein the viewable data set is transmitted through the first output interface.

8. The node according to claim 1, wherein the first output interface comprises a digital video interface.

9. The node according to claim 1, wherein the viewable data comprises red-, green-, and blue-formatted pixel data.

10. The node according to claim 1, wherein the non-viewable data set comprises at least one of a depth value and a transparency value associated with pixel values of the viewable data set.

11. A method of generating an image frame for assembly by a compositing system, comprising:
generating a viewable data set and a non-viewable data set from a geometric data set; and
transmitting, by a rendering node, the viewable and non-viewable data sets to a compositor.

12. The method according to claim 11, wherein transmitting the viewable and non-viewable data sets further comprises transmitting the viewable and non-viewable data sets through a first output interface of the rendering node.

13. The method according to claim 11, wherein transmitting the viewable and non-viewable data sets further comprises transmitting the viewable and non-viewable data sets through respective first and second output interfaces of the rendering node.

14. The method according to claim 11, wherein transmitting the viewable and non-viewable data sets further comprises transmitting the viewable and non-viewable data sets through a digital video interface.

15. The method according to claim 11, wherein transmitting the viewable data set comprises transmitting a red-, green-, and blue-formatted pixel data set.

16. The method according to claim 11, wherein transmitting the non-viewable data set comprises transmitting transparency and depth values of the viewable data set.

17. A network for generating image frames, comprising:
a plurality of rendering nodes operable to respectively generate a viewable data set and a non-viewable data set, and further operable to transmit the viewable and non-viewable data sets; and
a compositor interconnected with the plurality of rendering nodes and operable to respectively receive the viewable and non-viewable data sets from the plurality of rendering nodes and operable to assemble a composite image from the viewable and non-viewable data sets.

18. The network according to claim 17, wherein each of the rendering nodes further comprises a respective graphics device comprising an output interface, the viewable and non-viewable data sets transmitted through the output interface of the respective rendering node.

19. The network according to claim 17, wherein each of the rendering nodes further comprises a respective graphics device comprising first and second output interfaces, the viewable and non-viewable data sets of each rendering node transmitted to the compositor through the respective first and second output interfaces.

20. The network according to claim 19, wherein the first and second output interfaces each comprise a digital video interface.

21. The network according to claim 17, wherein the compositor further comprises a plurality of digital video interfaces, the viewable and non-viewable data sets transmitted by each rendering node received by the compositor on a respective digital video interface.

22. The network according to claim 17, wherein the compositor further comprises a plurality of first and second digital video interfaces, the viewable and non-viewable data sets transmitted by each rendering node respectively received by the compositor on respective first and second digital video interfaces.

23. The network according to claim 17, wherein the non-viewable data set comprises a depth value and a transparency value, the compositor operable to perform depth testing and alpha blending on the viewable data set.
